(19) United States
(12) Patent Application Publication
(10) Pub. No.: US 2020/0114707 A1
(43) Pub. Date: Apr. 16, 2020

(54) TIRE AIR PRESSURE DETECTION SYSTEM, VEHICLE BODY APPARATUS, AND TIRE APPARATUS

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-Shi (JP)

(72) Inventor: Qiying LI, Yokkaichi, Mie (JP)

(21) Appl. No.: 16/470,466

(22) PCT Filed: Dec. 12, 2017
(86) PCT No.: PCT/JP2017/044579

§ 371 Date: Jun. 17, 2019

(30) Foreign Application Priority Data
Dec. 20, 2016 (JP) 2016-247160

(51) Int. Cl. B60C 23/04

(52) U.S. Cl. CPC B60C 23/0455

(57) ABSTRACT

A tire-side apparatus includes: a first storage unit storing an identifier for identifying the tire-side apparatus. A signal reception strength measurement unit measures signal reception strengths of measurement signals. A specification unit specifies the number of received measurement signals. A second storage unit stores the number of the received measurement signals transmitted sequentially from a vehicle body-side apparatus to tire-side apparatuses corresponding to a plurality of tires, and a signal reception order in which the measurement signal with the highest signal reception strength among the received measurement signals was received. The tire-side apparatus transmits a response signal including an identifier and information indicating the reception order and number of measurement signals stored in the second storage unit, and the vehicle body-side apparatus determines a correspondence based on comparison of the information indicating the number of measurement signals and signal reception order transmitted from the multiple tire-side apparatuses.

### CROSS-REFERENCE TO RELATED APPLICATIONS

This application is the U.S. national stage of PCT/JP2017/044579 filed Dec. 12, 2017, which claims priority of Japanese Patent Application No. JP 2016-247160 filed Dec. 20, 2016, the contents of which are incorporated herein.

### TECHNICAL FIELD

The present disclosure relates to a tire air pressure detection system.

### BACKGROUND

A tire pressure monitoring system (TPMS) is used which detects the air pressures of multiple tires mounted on a vehicle and generates a warning or the like if a detected air pressure is abnormal. JP 2005-309958A discloses a tire pressure monitoring system including: detection apparatuses including sensors provided on respective tires; a vehicle body-side monitoring apparatus that receives detection signals from the detection apparatuses; and transmitters (LF (low frequency) antennas) that are provided near the tires and transmit LF signals to the detection apparatuses. With a TPMS having this kind of configuration, LF signals are transmitted sequentially from the transmitters to the corresponding detection apparatuses. Upon receiving the LF signals, the detection apparatuses respond to the monitoring apparatuses with RF (radio frequency) signals, and thus the monitoring apparatuses associate the tires with the detection results. Due to the LF signals transmitted from the transmitters at this time being received by the detection apparatuses on the tires other than the corresponding detection apparatuses, the occurrence of cross-talk, which makes it unclear which of the detection apparatuses of the tires the response signal is from, is a problem. In particular, JP 2005-309958A proposes that, as a counter-measure for when cross-talk occurs, a threshold value is set such that only the signal reception strength at a time of receiving the signal from the corresponding transmitter is larger than the threshold value, and a response is given only if the signal reception strength is larger than the threshold value. Similarly, in JP 2008-074164A, a response signal responding to an LF signal (trigger signal) transmitted from a corresponding transmitter to the detection apparatus includes the signal reception strength of the trigger signal, and if the signal reception strength included in the response signal is within a predetermined range, the ID of the detection apparatus included in the response signal is registered.

In the systems disclosed in JP 2005-309958A and JP 2008-074164A, it is determined whether or not there is a response from a target detection apparatus by determining whether or not the signal reception strength is greater than or equal to the threshold value and whether or not the signal reception strength is within a predetermined range. However, if a threshold value or a predetermined range is set, there is a possibility that accurate determination will not be possible, as in a case in which, when the receiver of the detection apparatus is in a dead band for LF signals when the vehicle is stopped, or the like, the signal reception strength is considered lower than the threshold value despite being a trigger signal for the target detection apparatus, and no response is given. Furthermore, although the threshold value is to be changed according to the type of vehicle, the type of tire to be mounted, and the like, changing the setting of the threshold value according to the type is complicated.

The present disclosure was made in view of these circumstances, and aims to provide a tire air pressure detection system, a vehicle body-side apparatus, and a tire-side apparatus, according to which it is possible to accurately identify each tire and detect each air pressure while using the signal reception strength on the tire side, and without setting a threshold value or a signal reception strength range with respect to the signal reception strength.

### SUMMARY

A tire air pressure detection system according to an aspect of the present disclosure is a tire air pressure detection system including: tire-side apparatuses that are respectively provided on a plurality of tires mounted on a vehicle, each tire-side apparatus having a sensor for detecting air pressure of the tire, a tire-side reception unit for wirelessly receiving a signal requesting transmission of a result of measurement performed by the sensor, and a tire-side transmission unit for wirelessly transmitting a measurement result in response to the request; and a vehicle body-side apparatus that is provided on a vehicle body of the vehicle and has a vehicle body-side transmission unit and a vehicle body-side reception unit that are provided on the vehicle body of the vehicle and are for wirelessly transmitting and receiving signals to and from the tire-side apparatuses, the vehicle body-side apparatus acquiring air pressures of the respective tires and detecting reduction of the air pressures, wherein each of the tire-side apparatuses includes: a first storage unit configured to store an identifier for identifying the tire-side apparatus in which the first storage unit is included; a signal reception strength measurement unit configured to measure a signal reception strength of each of the measurement signals; a specification unit configured to specify the number of measurement signals received by the tire-side reception unit; a second storage unit configured to store the number of the received measurement signals among the measurement signals transmitted sequentially from the vehicle body-side apparatus to the tire-side apparatuses corresponding to the plurality of tires, and a signal reception order in which a measurement signal with the highest signal reception strength among the received measurement signals was received; and a tire-side transmission control unit configured to cause a response signal, which includes information indicating the number of measurement signals and the signal reception order stored in the second storage unit and an identifier stored in the first storage unit, to be transmitted to the vehicle body-side apparatus, and the vehicle body-side apparatus includes: a vehicle body-side transmission control unit configured to cause measurement signals to be sequentially transmitted from the vehicle body-side transmission unit in accordance with the address order to the tire-side apparatuses of the plurality of tires; a vehicle body-side reception control unit configured to receive response signals through the vehicle body-side reception unit after transmission of the measurement signals; and a control unit configured to retrieve the identifiers, the numbers of measurement signals, and the signal reception orders included in the response signals transmitted from the plurality of tire-side apparatuses and, based on comparison, associate tire positions corresponding to the address order and the identifiers.

A vehicle body-side apparatus according to an aspect of the present disclosure is a vehicle body-side apparatus that is provided on a vehicle body of a vehicle and includes: a transmission unit and a reception unit for transmitting and receiving information using wireless signals to and from tire-side apparatuses provided in a plurality of tires mounted on the vehicle, the vehicle body-side apparatus including: a transmission control unit configured to sequentially cause measurement signals to be transmitted from the transmission unit in accordance with a predetermined address order to the tire-side apparatuses of the plurality of tires; a reception control unit configured to receive response signals through the reception unit after transmission of the measurement signals; and a control unit configured to retrieve the identifiers, the numbers of measurement signals, and the signal reception orders included in the response signals transmitted from the plurality of tire-side apparatuses and, based on mutual comparison of the retrieved numbers of measurement signals and the signal reception order, associate tire positions corresponding to the predetermined address order and the identifiers.

A tire-side apparatus according to an aspect of the present disclosure is a tire-side apparatus that is provided on a tire of a vehicle and includes a transmission unit and a reception unit for transmitting and receiving information through wireless signals to and from a vehicle body-side apparatus provided on a vehicle body of the vehicle, the tire-side apparatus including: a first storage unit configured to store an identifier for identifying the tire-side apparatus in which the first storage unit is included; a signal reception strength measurement unit configured to measure a signal reception strength of each of the measurement signals; a specification unit configured to specify the number of measurement signals received by the reception unit; a second storage unit configured to store the specified number of the received measurement signals among the measurement signals transmitted sequentially from the vehicle body-side apparatus to the tire-side apparatus, and a signal reception order in which a measurement signal with the highest signal reception strength among the received measurement signals was received; and a transmission control unit configured to cause a response signal, which includes information indicating the number of measurement signals and the signal reception order stored in the second storage unit and an identifier stored in the first storage unit, to be transmitted to the vehicle body-side apparatus.

Note that the present application can not only be realized as a tire air pressure detection system including such characteristic configurational portions, and a vehicle body-side apparatus and tire-side apparatus included in the system, but can also be realized as a tire air pressure detection method including characteristic steps, and can be realized as a program for causing a computer to execute the steps. Also, the present application can be realized as a semiconductor integrated circuit that realizes part or all of the tire air pressure detection system, the vehicle body-side apparatus, and the tire-side apparatus, and can be realized as another system including the tire air pressure detection system, the vehicle body-side apparatus, or the tire-side apparatus.

### Effect of the Disclosure

According to the description above, sensors of tires can be identified accurately without setting a threshold value for a signal reception strength or a signal reception strength range, and the air pressures of the tires can be accurately identified and detected.

### BRIEF DESCRIPTION OF DRAWINGS

FIG. 1 is a schematic diagram showing an arrangement of configurational portions of a tire air pressure detection system of the present embodiment.

FIG. 2 is a block diagram showing a configuration of the tire air pressure detection system of the present embodiment.

FIG. 3 is an illustrative view for describing information stored in a storage unit of a tire-side apparatus.

FIG. 4 is a flowchart showing an example of processing for registering an identifier and a tire position, the processing being performed by the tire air pressure detection system.

FIG. 5 is a flowchart showing an example of processing for registering an identifier and a tire position, the processing being performed by the tire air pressure detection system.

FIG. 6 is an illustrative diagram showing, in an emphasized manner, cases in which FLAG data in FIG. 3 is “010”.

### DETAILED DESCRIPTION OF PREFERRED EMBODIMENTS

First, embodiments of the present disclosure will be listed and described. At least some of the embodiments described below may be combined as appropriate.

A tire air pressure detection system according to an aspect of the present disclosure is a tire air pressure detection system including: tire-side apparatuses that are respectively provided on a plurality of tires mounted on a vehicle, each tire-side apparatus having a sensor for detecting air pressure of the tire, a tire-side reception unit for wirelessly receiving a signal requesting transmission of a result of measurement performed by the sensor, and a tire-side transmission unit for wirelessly transmitting a measurement result in response to the request; and a vehicle body-side apparatus that is provided on a vehicle body of the vehicle and has a vehicle body-side transmission unit and a vehicle body-side reception unit that are provided on the vehicle body of the vehicle and are for wirelessly transmitting and receiving signals to and from the tire-side apparatuses, the vehicle body-side apparatus acquiring air pressures of the respective tires and detecting reduction of the air pressures, wherein each of the tire-side apparatuses includes: a first storage unit configured to store an identifier for identifying the tire-side apparatus in which the first storage unit is included; a signal reception strength measurement unit configured to measure a signal reception strength of each of the measurement signals; a specification unit configured to specify the number of measurement signals received by the tire-side reception unit; a second storage unit configured to store the number of the received measurement signals among the measurement signals transmitted sequentially from the vehicle body-side apparatus to the tire-side apparatuses corresponding to the plurality of tires, and a signal reception order in which a measurement signal with the highest signal reception strength among the received measurement signals was received; and a tire-side transmission control unit configured to cause a response signal, which includes information indicating the number of measurement signals and the signal reception order stored in the second storage unit and an identifier stored in the first storage unit, to be transmitted to the vehicle body-side apparatus, and the vehicle body-side apparatus includes: a vehicle body-side transmission control unit configured to cause measurement signals to be sequentially transmitted from the vehicle body-side transmission unit in accordance with the address order to the tire-side apparatuses of the plurality of tires; a vehicle body-side reception control unit configured to receive response signals through the vehicle body-side reception unit after transmission of the measurement signals; and a control unit configured to retrieve the identifiers, the numbers of measurement signals, and the signal reception orders included in the response signals transmitted from the plurality of tire-side apparatuses and, based on comparison, associate tire positions corresponding to the address order and the identifiers.

In one aspect of the present disclosure, measurement signals are transmitted from the vehicle body-side apparatus to the respective tire-side apparatuses, and the tire-side apparatuses measure the signal reception strengths of the received signals, and store the number of measurement signals of the received signals and the signal reception orders of the signals with the highest signal reception strengths. The tire-side apparatuses each transmit information on the number of measurement signals and the signal reception order, which is stored therein, as well as an identifier identifying the tire-side apparatus, as a response to the vehicle body-side apparatus. By comparing the information transmitted from each tire-side apparatus in the vehicle body-side apparatus, it is possible to determine the tire positions of the tires provided with the tire-side apparatuses by process of elimination. That is, if a measurement signal has been received before the signal with the highest signal reception strength, it is determined that the signal to the apparatus is not first in the address order, and if a measurement signal has been received after the signal with the highest signal reception strength, it is determined that the signal to that apparatus is not last in the address order.

In a tire air pressure detection system according to an aspect of the present disclosure, if the control unit receives a plurality of response signals after transmitting a request signal requesting transmission of a measurement result to any one of the tire-side apparatuses, the control unit stores the correspondence between the tire position corresponding to a request destination of the request signal and the identifiers included in the response signals, and based on the identifiers, numbers of response signals, and response orders included in the response signals, and based on a correspondence between the tire position and an identifier stored in advance, the control unit associates the tire position corresponding to the address order and the identifier.

In an aspect of the present disclosure, if cross-talk in which a response comes back also from other tire-side apparatuses regardless of the fact that the measurement result was requested to one tire-side apparatus, information on the identifiers of the tire-side apparatuses that responded is stored. In the vehicle body-side apparatus, the tire positions of the tires provided with the tire-side apparatuses can be determined more accurately by referencing information obtained when cross-talk occurs, with respect to candidates transmitted from the tire-side apparatuses.

A vehicle body-side apparatus according to an aspect of the present disclosure is a vehicle body-side apparatus that is provided on a vehicle body of a vehicle and includes: a transmission unit and a reception unit for transmitting and receiving information using wireless signals to and from tire-side apparatuses provided in a plurality of tires mounted on the vehicle, the vehicle body-side apparatus including: a transmission control unit configured to sequentially cause measurement signals to be transmitted from the transmission unit in accordance with a predetermined address order to the tire-side apparatuses of the plurality of tires; a reception control unit configured to receive response signals through the reception unit after transmission of the measurement signals; and a control unit configured to retrieve the identifiers, the numbers of measurement signals, and the signal reception orders included in the response signals transmitted from the plurality of tire-side apparatuses and, based on mutual comparison of the retrieved numbers of measurement signals and the signal reception order, associate tire positions corresponding to the predetermined address order and the identifiers.

In one aspect of the present disclosure, similarly to (1) described above, the measurement signals are transmitted from the vehicle body-side apparatus to the tire-side apparatuses, and in response thereto, the numbers of measurement signals in the signals respectively received by the tire-side apparatuses, and the reception orders of the signals with the highest signal reception strengths, that is, the signals to the tire-side apparatuses, are stored. With the vehicle body-side apparatus, the tire positions of the tires provided with the tire-side apparatuses can further be determined through process of elimination based on comparison of the numbers of measurement signals and the reception orders stored in the tire-side apparatuses.

A tire-side apparatus according to an aspect of the present disclosure is a tire-side apparatus that is provided on a tire of a vehicle and includes a transmission unit and a reception unit for transmitting and receiving information through wireless signals to and from a vehicle body-side apparatus provided on a vehicle body of the vehicle, the tire-side apparatus including: a first storage unit configured to store an identifier for identifying the tire-side apparatus in which the first storage unit is included; a signal reception strength measurement unit configured to measure a signal reception strength of each of the measurement signals; a specification unit configured to specify the number of measurement signals received by the reception unit; a second storage unit configured to store the specified number of thereceived measurement signals among the measurement signals transmitted sequentially from the vehicle body-side apparatus to the tire-side apparatus, and a signal reception order in which a measurement signal with the highest signal reception strength among the received measurement signals was received; and a transmission control unit configured to cause a response signal, which includes information indicating the number of measurement signals and the signal reception order stored in the second storage unit and an identifier stored in the first storage unit, to be transmitted to the vehicle body-side apparatus..

In one aspect of the present disclosure, similarly to (1) described above, with the tire-side apparatus, the signal reception strengths of the received signals among the measurement signals transmitted from the vehicle body-side apparatus to the tire-side apparatuses are each measured, and the number of received signals and the reception order of the signal with the highest signal reception strength are stored. In the tire-side apparatus, the number of measurement signals that were stored and the reception order of the signal with the highest signal reception strength, that is, the signal to the tire-side apparatus, are transmitted as a response signal to the vehicle body-side apparatus. Upon receiving the response signal, the vehicle body-side apparatus compares these pieces of information to determine the correspondence between the tire positions and the identifiers of the tire-side apparatuses.

A specific example of a tire air pressure detection system according to an embodiment of the present disclosure will be described hereinafter with reference to the drawings. It should be noted that the present disclosure is not limited to these illustrative examples, and is indicated by the claims, and meanings equivalent to the claims and all changes within the technical scope are intended to be encompassed herein.

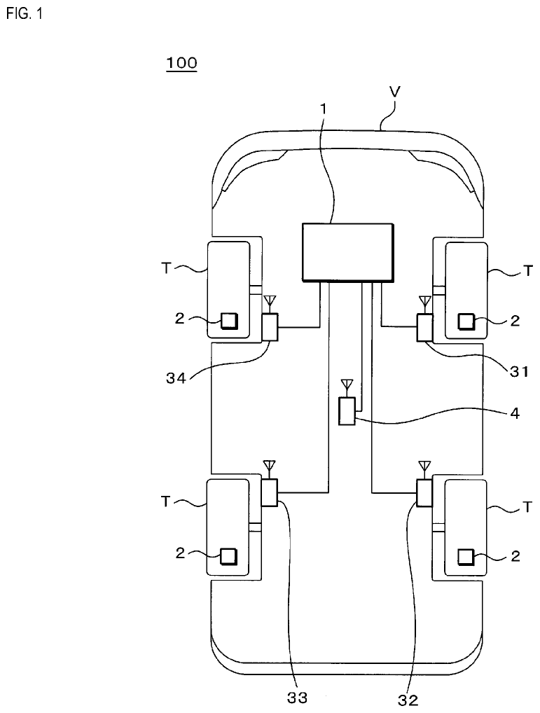

FIG. 1 is a schematic diagram showing an arrangement of configurational portions of a tire air pressure detection system 100 of the present embodiment. The tire air pressure detection system 100 of the present embodiment includes: a vehicle body-side apparatus 1; and tire-side apparatuses 2, the number of which corresponds to the number of tires T that are mounted.

The vehicle body-side apparatus 1 is installed in or below an instrument panel. The vehicle body-side apparatus 1 is connected by signal lines to transmission antennas 31 to 34 provided on tire houses of the tires T.

The transmission antenna 31 is provided at a position corresponding to the front-right tire T, the transmission antenna 32 is provided at a position corresponding to the rear-right tire T, the transmission antenna 33 is provided at a position corresponding to the rear-left tire T, and the transmission antenna 34 is provided at a position corresponding to the front-left tire T. The transmission tires 31 to 34 are antennas that transmit wireless signals to the tire-side apparatuses 2. An LF (low frequency) band (e.g., 125 kHz), for example, is used as the frequency band of the carrier waves for the signals transmitted from the transmission antennas 31 to 34. The frequency band is not limited to this, and it is sufficient to use a frequency band that is different from that of a later-described reception antenna 4 and has prominent attenuation due to distance.

The vehicle body-side apparatus 1 is connected by a signal line to a reception antenna 4 provided on the roof of a vehicle V. The reception antenna 4 is provided in the lining of the roof of the vehicle V, for example. The reception antenna 4 receives signals transmitted from the tire-side apparatuses 2. The frequency band of the carrier waves to be received is an RF (radio frequency) band (e.g., 300 MHz, UHF band). The frequency band is not limited thereto.

The tire-side apparatuses 2 are sensor units that are each provided in a wheel of a tire, and for example, measure air pressure in the tire with a pressure sensor using a diaphragm or the like, and wirelessly transmit air pressure signals indicating the measurement result.

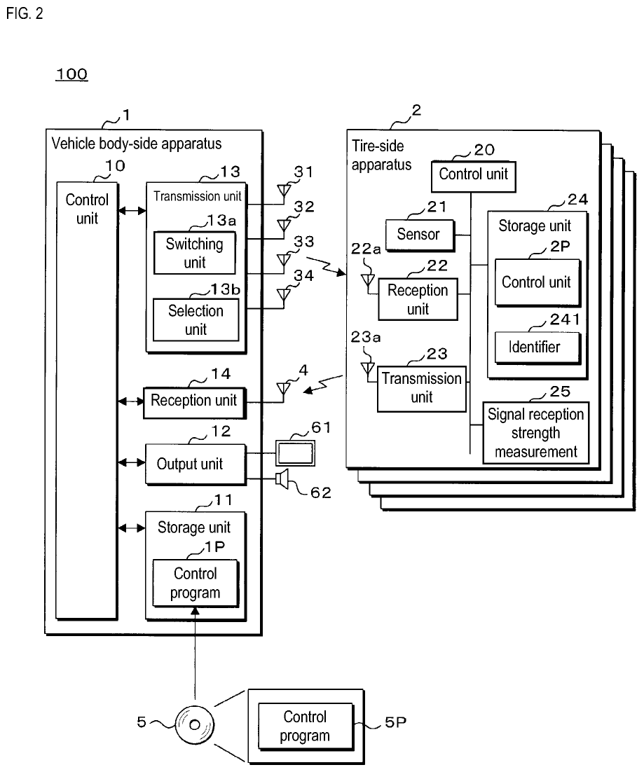

FIG. 2 is a block diagram showing a configuration of the tire air pressure detection system 100 of the present embodiment. The vehicle body-side apparatus 1 is a so-called BCM (body control module) unit that performs overall control of locking and unlocking door locks of the vehicle V and overall control of actuators for the body system, such as lighting devices inside and outside of the vehicle. The vehicle body-side apparatus 1 includes: a control unit 10; a storage unit 11; an output unit 12; a reception unit 14; and a transmission unit 13, and operates by receiving a supply of power from the battery.

The control unit 10 is a micro-controller that uses one or multiple CPUs (central processing units) or a multi-core CPU and includes a ROM (read only memory), a RAM (random access memory), an input/output interface, a timer, and the like. The control unit 10 controls the configurational units based on a control program 1P stored in the storage unit 11. Note that the control program 1P may also be stored in an internal ROM of the control unit 10.

A non-volatile memory such as a flash memory is used as the storage unit 11. The storage unit 11 stores various types of information to be referenced by the control unit 10 and stores the above-described control program 1P. Note that the storage unit 11 stores the correspondence between identifiers 241 transmitted from the tire-side apparatuses 2 as described later, and identification information (tire positions such as front-right, front-left, rear-right, rear-left, and spare) of the tires T. The control program 1P stored in the storage unit 11 may also be stored in a computer-readable storage medium 5. The storage unit 11 stores a control program 5P that is read out from the storage medium 5 by a reading apparatus (not shown). The storage medium 5 is an optical disk such as a CD (compact disc)-ROM, a DVD (digital versatile disc)-ROM, or a BD (Blu-ray (registered trademark) Disc), a flexible disk, a magnetic disk such as a hard disk, a magneto-optical disk, a semiconductor memory, or the like. Also, a control program 5P according to Embodiment 1 may be downloaded from an external computer (not shown) connected to a communication network (not shown) and may be stored in the storage unit 11.

A display 61 and a speaker 62 are connected to the output unit 12. Only one of the display 61 and the speaker 62 may also be provided. The output unit 12 outputs a control signal to the display 61 and outputs an audio signal to the speaker 62 according to control performed by the control unit 10.

The display 61 is a display light provided in a panel for instruments such as a speedometer in the instrument panel. An LED (light emitting diode) may be used thereas. A head-up display may also be used thereas. A display panel of a type built into a touch panel to be used in a navigation system or the like, such as an LCD (liquid crystal display) or organic EL (electro luminescence) may also be used as the display 61. The display 61 displays an image or text based on the signal output from the output unit 12.

The speaker 62 generates audio or a sound effect based on the signal output from the output unit 12.

A transmission module that is connected to the transmission antennas 31 to 34 and includes a modulator for modulating signals to be transmitted from the transmission antennas 31 to 34 is used as the transmission unit 13. Note that a switching unit 13a is included inside of the transmission unit 13, and one part or all of the multiple transmission antennas 31 to 34 can be used upon being selected by the switching unit 13a. Also, the transmission unit 13 includes a selection unit 13b that can select the signal output and can select any one of the transmission strengths from the transmission antennas 31 to 34 from multiple output stages (strengths) using the selection unit 13b.

The reception unit 14 is connected to the reception antenna 4, and a reception circuit including an amplifier, a filter circuit, and a demodulator for electromagnetic waves received by the reception antenna 4 is used thereas.

The tire-side apparatus 2 includes: a control unit 20, a sensor 21, a transmission unit 23, a reception unit 22, a storage unit 24, and a signal reception strength measurement unit 25. The tire-side apparatus 2 operates by receiving a supply of power from a battery or a built-in battery.

The control unit 20 is, for example, a micro-controller that uses one or multiple CPUs or a multi-core CPU, and includes a ROM, a RAM, an input/output interface, a timer, and the like. The CPU of the control unit 20 is connected to the sensor 21, the reception unit 22, the transmission unit 23, and the storage unit 24 via the input/output interface.

The sensor 21 uses a diaphragm, for example, to measure the air pressure of the tire T based on the amount of change in the diaphragm, which changes according to the magnitude of the pressure. The sensor 21 outputs the measurement result to the control unit 20 as a signal (having a voltage level corresponding to the air pressure). Note that the sensor 21 may also be configured to further output a signal indicating the temperature to the control unit 20 using the temperature sensor.

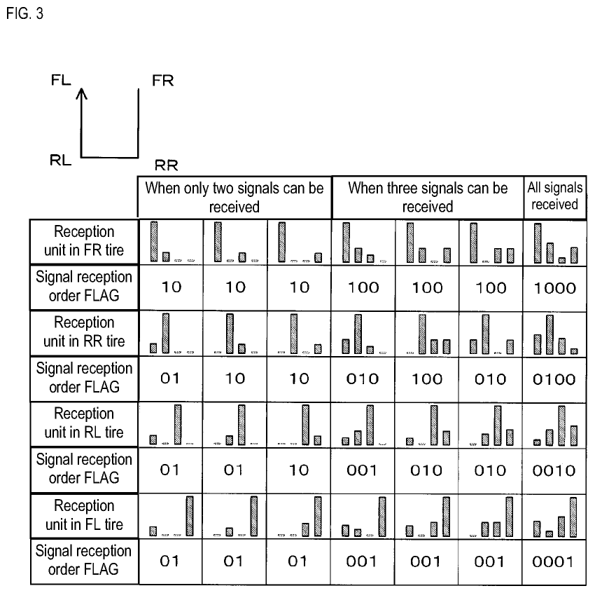

A non-volatile memory such as a flash memory is used as the storage unit 24. The storage unit 24 stores a control program 2P for causing the control unit 20 to control the operation of the configurational units of the tire-side apparatus 2, that is, for causing the control unit 20 to perform processing for transmitting and receiving the measurement result of the tire air pressure, which will be described later. Also, unique identifiers 241 are stored in advance in the storage units 24 such that the multiple tire-side apparatuses 2 can be identified from each other. Note that although FIG. 2 illustrates the control unit 20 and the storage unit 24 as separate configurational units, it is also possible to use a configuration in which the storage unit 24 is included inside of the control unit 20, and the control program 2P and the identifier 241 may also be stored in the built-in storage unit of the control unit 20. It is assumed that the identifiers 241 are XXX, XXY, XXZ, and XXW, for example. As will be described later, the storage unit 24 stores flag data indicating the number of measurement signals transmitted from the vehicle body-side apparatus 1 and the reception order of the signal with the highest strength among them (see FIG. 3).

The reception unit 22 cancels out the component of the carrier wave from the multiple wireless signals received by the antenna 22a to extract the received signal, and outputs the extracted received signal to the control unit 20. In the present embodiment, the LF band is used as the frequency band for the carrier wave of the wireless signal received by the antenna 22a. The frequency band of the carrier wave received by the antenna 22a is not limited to a frequency band, as long as it corresponds to the transmission antennas 31 to 34 on the vehicle body side.

The transmission unit 23 is a circuit that modulates the signal input by the control unit 20 using the carrier wave and transmits the wireless signal through a transmission antenna 23a. In the present embodiment, the RF band (UHF band) is used as the frequency band for the carrier wave of the signal transmitted from the transmission antenna 23a. However, the frequency band to be used by the transmission antenna 23a is not limited to this frequency band, as long as it corresponds to the reception antenna 4 on the vehicle body side.

The signal reception strength measurement unit 25 measures the signal reception strength of the wireless signal received by the antenna 22a using an amplification circuit or the like and outputs the result to the control unit 20.

With the tire air pressure detection system 100 configured in this manner, the control unit 10 of the vehicle body-side apparatus 1 periodically acquires the air pressures of the tires T. For example, the control unit 10 of the vehicle body-side apparatus 1 transmits a request to transmit the sequential measurement results to the tire-side apparatuses 2 of the tires T from the transmission antennas 31 to 34 using an LF signal. When a transmission request addressed to the tire-side apparatus 2 is received, the tire-side apparatus 2 transmits the measurement result obtained by measuring with the sensor 21 along with the identifier 241 stored in the storage unit 24 from the transmission antenna 23a of the transmission unit 23, using an RF signal. The control unit 10 of the vehicle body-side apparatus 1 receives a response by the RF signal in the reception unit 14 via the reception antenna 4, and identifies which tire T the measurement result belongs to according to the information of the identifier 241.

Then, upon acquiring the air pressures of the tires T, the control unit 10 compares the air pressures with a threshold value for air pressure reduction, and if it is determined that an air pressure is less than or equal to the threshold value, a warning indicating that the air pressure of that tire T has decreased is output by the display 61 or the speaker 62 from the output unit 12. The warning includes information specifying the tire position of the tire T in which the air pressure reduction occurred. For example, the display 61 illuminates a warning lamp indicating one of the four wheels, or displays text information saying “The air pressure in the front-right tire has decreased”. For example, the speaker 62 outputs a sound effect along with the warning lamp, or outputs audio reciting “The air pressure in the front-right tire has decreased”. Note that the threshold value to be referenced during comparison may also be a threshold value corresponding to the types of the vehicle V and the tire T. In this manner, a user can be notified of the necessity of maintenance of the tire T in which a reduction of air pressure has occurred. Note that suitable travel control can be performed by performing notification of air pressure reduction to the travel control system of the vehicle V.

At this time, in the tire air pressure detection system 100, the identifiers 241 received along with the signals of the measurement results from the tire-side apparatuses 2 need to be stored (registered) in the storage unit 11 in correspondence with the tire positions of front-right, rear-right, rear-left, and front-left (spare may also be included). This is because the relationships between the tire-side apparatuses 2 and the tire positions are not fixed, since an entire wheel of a tire T can be exchanged. Registration of the correspondence between the identifiers 241 and the tire positions is initially (at the time of shipping) registered, but other than that, it is performed when it is detected that cross-talk has occurred between the tire-side apparatuses 2 by the vehicle body-side apparatus 1. The occurrence of cross-talk is detected when, for example, measurement results are received as response signals from multiple tire-side apparatuses 2, despite the fact that the control unit 10 of the vehicle body-side apparatus 1 has caused the requested signal of the measurement value to be transmitted from the transmission antenna 31 to the tire-side apparatus 2 corresponding to the front-rear tire T. Then, at this time, the control unit 10 of the vehicle body-side apparatus 1 stores the identifiers 241 corresponding to the multiple tire-side apparatuses 2 that responded to the transmission request in correspondence with the information indicating the address of the transmission request.

Note that this procedure may also be performed when the control unit 10 detects a press of a reset button provided on the vehicle body-side apparatus 1 in a state in which a supply of power from the battery is being received (in which the ignition switch is on and accessories are on). The control unit 10 may also automatically perform this procedure upon detecting that a tire T has been exchanged.

Also, before the description of processing for registering the identifiers 241 and the tire positions, which is performed when cross-talk occurs, the information used in this processing will be described. FIG. 3 is an illustrative view for describing information stored in the storage units 24 of the tire-side apparatuses 2. As described above, cross-talk is a phenomenon in which, despite the fact that a signal requesting a measurement value from one of the transmission antennas 31 to 34 was transmitted to the tire-side apparatus 2 corresponding to the tire T of the address from one of the transmission antennas 31 to 34, the request signal reaches a tire-side apparatus 2 corresponding to a tire T other than the tire T of the address as well, and the measurement result is transmitted as the response signal. In view of this, the reception state of the signal from the vehicle body-side apparatus 1 to the other apparatus is measured by the tire-side apparatus 2. FIG. 3 shows the reception states of the tire-side apparatuses 2 in the case where specific signals (measurement signals) are transmitted in a predetermined sequence from the vehicle body-side apparatus 1. The specific signals are transmitted in the order of rear-right (RR), rear-left (RL), and front-left (FL) after the front-right (FR) transmission antenna 31. Then, the reception states of these signals are listed in the reception units 22 of the tire-side apparatuses 2, which is as shown in FIG. 3.

For example, in FIG. 3, if only two specific signals transmitted sequentially from the vehicle body-side apparatus 1 can be received by the reception unit 22 of the tire-side apparatus 2 of the front-right tire T, the combination of the signals is a signal that is transmitted from the transmission antenna 31 of the front-right tire T (FR), which is in the immediate vicinity, and a signal transmitted from one of the others. In this case, the signal transmitted from the transmission antenna 31 of the front-right tire T (FR) is received first by necessity, and moreover, should have the highest signal reception strength. The control unit 20 stores FLAG data corresponding to the number of received signals and the order of the signal with the highest signal reception strength among the received signals. In the example shown in FIG. 3, “10” is stored as the FLAG data in the storage unit 24 of the tire-side apparatus 2 of the front-right tire T. Note that, specifically, the FLAG data may also be constituted by 4-bit information indicating the number of received signals and 4-bit data indicating the order of the signal reception strength, or may also indicate “1” or “0” in 4 bits for each signal for a total of 16 bits (2 bytes) without indicating the number of signals. In the former case, if only two signals are received and the first reception signal strength is the highest, it is stored as 00101000(b) (=0x28), and in the latter case, if only two signals are received and the first reception signal is the strongest, it may be stored as (0x10ff) in hexadecimal.

If three of the specific signals transmitted from the transmission antennas 31 to 34 can be received in the reception portion 22 of the tire-side apparatus 2 of the front-right tire T, the combination thereof is a signal that is transmitted from the transmission antenna 31 of the front-right tire T (FR) and signals that are transmitted from some of the others. In this case, the signal transmitted from the transmission antenna 31 of the front-right tire T (FR) should be received first by necessity, and moreover, should have the highest signal reception strength. Accordingly, in this case, “100” is always stored as the FLAG data. If all of the specific signals transmitted from the transmission antennas 31 to 34 can be received, the signal transmitted from the transmission antenna 31 of the front-right tire T (FR) is received first, and furthermore, its signal reception strength is the highest. In this case, “1000” is always stored as the FLAG data.

Similarly, if only two of the specific signals transmitted sequentially from the vehicle body-side apparatus 1 can be received by the reception unit 22 of the tire-side apparatus 2 of the rear-right tire T, the combination thereof is a signal transmitted from the transmission antenna 32 of the rear-right tire T (RR), which is the nearest, and a signal transmitted from one of the others. In this case, the order in which the signal transmitted from the transmission antenna 32 of the rear-right tire T (RR) can be received is first in some cases and second in some cases. The signal transmitted from the transmission antenna 32 of the rear-right tire T (RR) can be received with the highest reception strength, but its reception order is not determined. If three of the specific signals transmitted from the transmission antennas 31 to 34 can be received, the combination is the signal transmitted from the transmission antenna 32 of the rear-right tire T (RR), which is the closest, and signals transmitted from some of the others. Although the signal transmitted from the transmission antenna 32 can be received with the highest strength, as shown in FIG. 3, its reception order is not third, but could be first or second.

In this manner, to summarize the possible reception states, candidates for the address order of the signal received with the highest strength can be narrowed down based on the number of received signals and the order of the signal received with the highest strength.

In view of this, each time the control unit 20 of the tire-side apparatus 2 receives a specific signal (measurement signal), FLAG data such as that shown in FIG. 3 is stored in the storage unit 24 and the FLAG data is transmitted to the vehicle body-side apparatus 1 as response signals for the measurement signals.

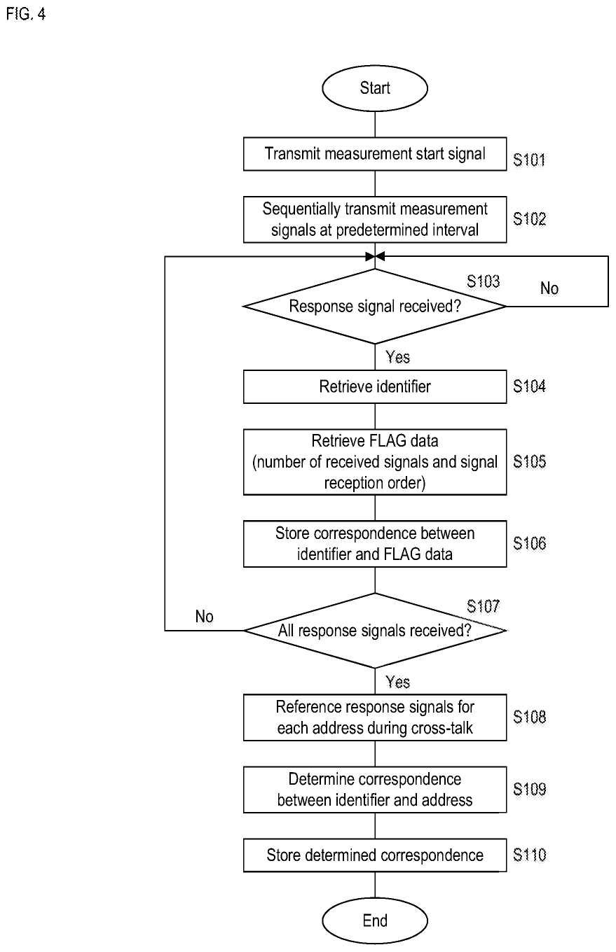

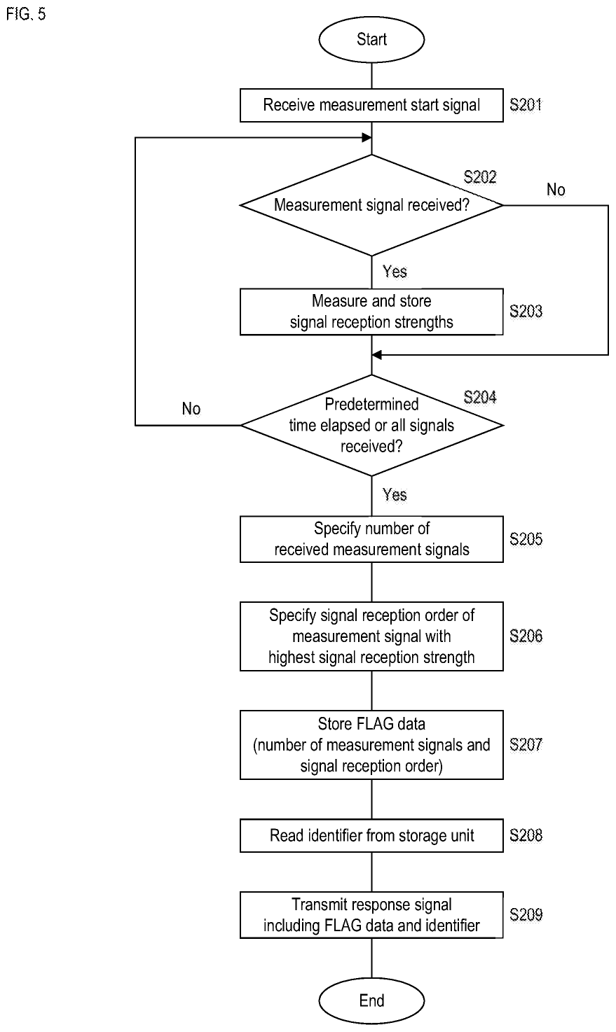

FIGS. 4 and 5 are flowcharts showing an example of processing for registering the identifiers 241 and the tire positions, the processing being executed by the tire air pressure detection system 100. The flowchart shown in FIG. 4 shows a processing procedure performed by the vehicle body-side apparatus 1. The control unit 10 of the vehicle body-side apparatus 1 uses the transmission unit 13 to cause measurement start signals to be transmitted all at once from all of the transmission antennas 31 to 34 to all of the tire-side apparatuses 2 (step S101). The measurement start signals are signals for starting measurement of the reception states in the tire-side measurements 2.

Thereafter, after an appropriate standby period, the control unit sequentially transmits measurement signals at a predetermined interval from the corresponding transmission antennas 31 to 34 in accordance with a predetermined address order (e.g., the order of front-right (FR), rear-right (RR), front-left (FL), and front-rear (FR)) (step S102). Note that at this time, the measurement signals are transmitted with the same transmission strength from the transmission antennas 31 to 34. Also, the transmission strength need only be set to a range spanning from a tire house to the inner portion of a wheel of a tire T mounted on at least one of the other tire houses.

Then, after step S102, the control unit 10 determines whether or not a response signal has been received by the reception antenna 4 from any tire-side apparatus 2 (step S103).

If it is determined in step S103 that no response signal has been received (S103: NO), the control unit 10 returns the processing to step S103 and waits until it is determined that a response signal has been received.

If it is determined in step S103 that a response signal has been received (S103: YES), the control unit 10 retrieves information on the identifiers 241 from the response signal received by the reception unit 14 (step S104). Furthermore, the control unit 10 retrieves the FLAG data from the response signal (step S105), and stores the correspondence between the identifiers 241 and the FLAG data that was transmitted therewith in the storage unit 24 (step S106). The control unit 10 determines whether or not response signals to the measurement signals to all of the tires T have been received (step S107).

If it is determined in step S107 that no response signal has been received (S107: NO), the control unit 10 returns the processing to step S102, selects the next tire T, and executes the processing.

Also, if it is determined in step S107 that a response signal has been received (S107: YES), the control unit 10 references the correspondence between the address of the transmission request during the occurrence of cross-talk, and the identifier 241 of the tire-side apparatus 2 that responded to that address, the correspondence having been stored in the storage unit 24 in advance (step S108). The control unit 10 determines the correspondence between the address order and the identifier 241 corresponding thereto based on the correspondence between the identifier 241 and the FLAG data (the number of signals received and the reception order), which was stored in step S106, and based on the correspondence between the address order referenced in step S108 and the identifier 241 of the apparatus that responded (step S109). The determination method for step S109 will be described in detail later. The control unit 10 stores the determined correspondence in the storage unit 24 (step S110) and ends the processing. The correspondence stored in the storage unit 24 is used in later air pressure detection processing.

The flowchart shown in FIG. 5 shows an example of a processing procedure performed by the tire-side apparatus 2. In the tire-side apparatus 2, upon receiving a measurement start signal through the reception unit 22 (step S201), the control unit 20 determines whether or not a measurement signal has been received from any of the transmission antennas 31 to 34 (step S202). If it is determined in step S202 that no measurement signal has been received (S202: NO), the control unit 20 advances the processing to step S204.

If it is determined in step S202 that a measurement signal has been received (S202: YES), the control unit 20 performs measurement using the signal reception strength measurement unit 25 of the received measurement signal and stores the signal reception strength chronologically (step S203). Note that the signal reception strength measurement unit 25 measures and continuously outputs the signal reception strength of the wireless signal received by the reception unit 22, and the control unit 20 acquires the corresponding signal reception strength.

Next, the control unit 20 determines whether or not a predetermined amount of time has elapsed since the measurement start signal was received, or whether or not measurement start signals from all of the transmission antennas 31 to 34 have been received (step S204). If it is determined that the predetermined amount of time has not elapsed and all of the measurement signals have not been received (S204: NO), the control unit 20 returns the processing to step S202 and repeats the processing until a total of four measurement signals have been received, or until a predetermined amount of time has elapsed.

If it is determined in step S204 that a predetermined amount of time has elapsed or that all of the request signals have been received (S204: YES), the control unit 20 specifies the number of received measurement signals based on the signal reception strengths of the measurement signals stored chronologically (step S205). Furthermore, the control unit 20 specifies the reception order of the measurement signal received with the highest signal reception strength (step S206).

Then, the control unit 20 stores the FLAG data including the number of specified measurement signals and the reception order of the highest-strength signal in the storage unit 24 (step S207). Note that the FLAG data may also be temporarily stored in a built-in RAM.

Next, the control unit 20 reads out the identifiers 241 from the storage unit 24 (step S208), transmits a response signal including the FLAG data and the identifier 241 to the vehicle body-side apparatus 1 (reception antenna 4) (step S209), and ends the processing.

A procedure of processing for determining the correspondence between an identifier and an address based on the FLAG data in the above-described step S109 will be described. First, when the results of measuring the air pressures of the tires T are to be acquired, the control unit 10 of the vehicle body-side apparatus 1 transmits a transmission request to the tire-side apparatuses 2 of the tires T using the transmission antennas 31, 32, 33, and 34, in the stated order. At this time, responses from the multiple tire-side apparatuses 2 are received, and the responses for the measurement results are received not only from the front-right (FR) tire-side apparatus 2, but also from the rear-right (RR) and front-left (FL) tire-side apparatuses 2. In this case, although the control unit 10 recognizes the occurrence of cross-talk, the control unit 10 stores the identifiers 241 and the FLAG data of the tire-side apparatuses 2 that responded, in correspondence with the information on the addresses (e.g., FR), and specifies them using the following procedure.

All of the states of cross-talk are as shown in FIG. 3. The transmission antennas 31 to 34 are considered as follows.

1: Tire T corresponding to the transmission antenna 31 that is first in the address order

First, the control unit 10 references the FLAG data from the tire-side apparatuses 2 involved in the cross-talk for the signal from the transmission antenna 31 provided the nearest to the front-right (FR) tire T, which is first in the address order. The FLAG data has the following pattern. The FLAG data that can be recorded in the tire-side apparatuses 2 in the tires T when the signals from the transmission antenna 31 can be received (the leftmost bar graph is present) and cross-talk has occurred is as follows.

Front-right (FR): “10”, “100”, or “1000”

Rear-right (RR): “01”, “010”, or “0100”

Rear-left (RL): “01”, “001”, “010”, or “0010”

Front-left (FL): “01”, “001”, or “0001”

Here, the head of the FLAG data is “0” by necessity for all but the tire-side apparatus 2 that is to respond to the signal from the transmission antenna 31. Due to this fact, if cross-talk occurs in the signal from the transmission antenna 31, the vehicle body-side apparatus 1 can specify that the tire-side apparatus 2 having “1” at the start of its FLAG data corresponds to the front-right tire T, as long as the FLAG data is sent from the tire-side apparatuses 2 in response to the signal.

2: Tire T corresponding to transmission antenna 34 that is last in the address order

Similarly, the FLAG data in the tire-side apparatuses involved in cross-talk with respect to the signal from the transmission antenna 34 provided the closest to the front-left (FL) tire T that is last in the address order has the following patterns. The FLAG data that can be recorded in the tire-side apparatuses 2 in the tires T when the signals from the transmission antenna 32 can be received (the second bar graph from the left is present) and cross-talk has occurred is as follows.

Front-right (FR): “10”, “100”, or “1000”

Rear-right (RR): “10”, “010”, “100”, or “0100”

Rear-left (RL): “10”, “010”, or “0010”

Front-left (FL): “01”, “001”, or “0001”

Here, the end of the FLAG data is “0” by necessity for all but the tire-side apparatus 2 that is to respond to the signal from the transmission antenna 34. Due to this fact, if cross-talk occurs in the signal from the transmission antenna 31, it is possible to specify that the tire-side apparatus 2 having “1” at the end of its FLAG data corresponds to the front-left tire T by the vehicle body-side apparatus 1, as long as the FLAG data is sent from the tire-side apparatuses 2 in response to the signal.

Thus, even in a state in which responses come back from the other tire-side apparatuses 2, the vehicle body-side apparatus 1 can specify the tire-side apparatus 2 of the tire T corresponding to the transmission antenna 31 that is first in the reception order and the tire-side apparatus 2 of the tire T corresponding to the transmission antenna 34 that is last.

3: Tires T corresponding to transmission antennas 32 and 33

The tire-side apparatus 2 of the tire T corresponding to the transmission antenna 32 that is second in the reception order and the tire-side apparatus 2 of the tire T corresponding to the transmission antenna 33 that is third can be distinguished as follows.

The FLAG data in the tire-side apparatuses involved in cross-talk with respect to the signal from the transmission antenna 32 provided the closest to the rear-right (RR) tire T has the following patterns. The FLAG data that can be recorded in the tire-side apparatuses 2 in the tires T when the signals from the transmission antenna 32 can be received (the second bar graph from the left is present) and cross-talk has occurred is as follows.

Front-right (FR): “10”, “100”, or “1000”

Rear-right (RR): “01”, “10”, “010”, “100”, or “0100”

Rear-left (RL): “01”, “001”, “010”, or “0010”

Front-left (FL): “01”, “001”, or “0001”

Similarly, the FLAG data in the tire-side apparatuses involved in cross-talk with respect to the signal from the transmission antenna 33 provided the closest to the rear-left (RL) tire has the following patterns. The FLAG data that can be recorded in the tire-side apparatuses 2 in the tires T when the signals from the transmission antenna 33 can be received (the second bar graph from the right is present) and cross-talk has occurred is as follows.

Front-right (FR): “10”, “100”, or “1000”

Rear-right (RR): “10”, “010”, “100”, or “0100”

Rear-left (RL): “01”, “10”, “001”, “010”, or “0010”

Front-left (FL): “01”, “001”, or “0001”

3-1: Case in which cross-talk does not mutually occur

In a state in which the front-right and front-left tire-side apparatuses 2 must be specified as described above if no cross-talk occurs mutually first between the rear-right transmission antenna 32 and the rear-left transmission antenna 33, one of them can be specified through process of elimination. Even if there is a response from the tire-side apparatus 2 of the rear-right tire T to the signal from the rear-left transmission antenna 33, the vehicle body-side apparatus 1 can specify through process of elimination, as long as there is no response from the tire-side apparatus 2 of the rear-left tire T to the signal from the rear-right transmission antenna 32. If cross-talk in which a tire-side apparatus 2 other than that of the rear-left tire T responds to the signal from the rear-right antenna 32 occurs, the front-right and rear-left tire-side apparatuses 2 can be specified, and therefore the remaining tire-side apparatus 2 can be associated with the rear-right tire T. Also, the further remaining tire-side apparatus 2 that responded to the signal from the rear-left transmission antenna 33 can be associated with the rear-left tire T. The same holds true for the inverse case as well.

3-2: Case in which cross-talk mutually occurs

Also, if cross-talk occurs mutually and symmetrically between the rear-right transmission antenna 32 and the rear-left transmission antenna 33, the following data in the list of FLAG data described above is recorded in the rear-right and rear-left tire-side apparatuses 2.

Rear-right (RR): “10”, “010”, “100”, or “0100”

Rear-left (RL): “01”, “001”, “010”, or “0010”

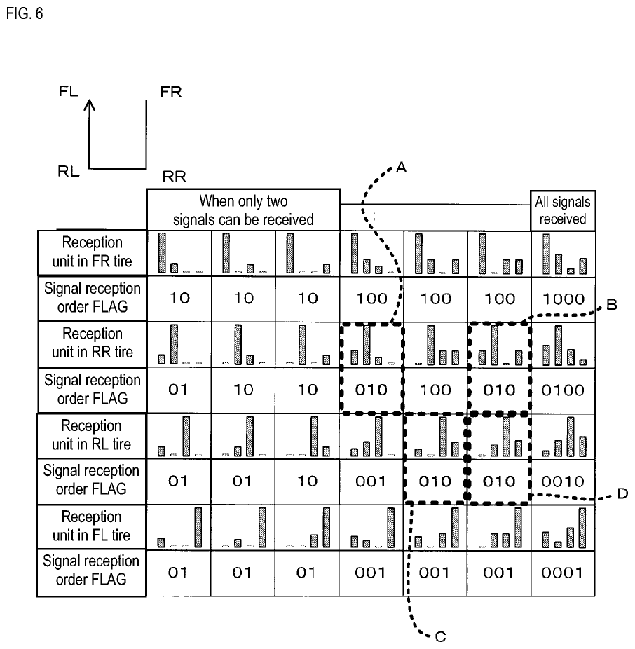

As long as the front-right and front-left tire-side apparatuses 2 can be specified, the tire-side apparatus 2 of the rear-right tire T and the tire-side apparatus 2 of the rear-left tire T can be specified based on the orders “10”, “01”, “100”, “001”, “0100”, and “0010” in these pieces of FLAG data. It is difficult to determine one of the tire-side apparatuses based on the orders only in the case where the FLAG data is “010”, but if FIG. 6, in which the case in which the FLAG data is “010” is emphasized in FIG. 3, is referenced, it is possible to make a distinction as follows. Among the cases in which the FLAG data is “010”, the cases in which cross-talk occurs mutually and symmetrically are the cases denoted by reference numerals A and D (the cases denoted by reference numerals B and C are specified in (3-1) above). Looking at A and D in FIG. 6, if the signal from the transmission antenna 31 has been responded to and the FLAG data is “010”, the vehicle body-side apparatus 1 can specify that the tire-side apparatus 2 of the identifier 241 corresponding to this FLAG data corresponds to the rear-right tire T. Similarly, if the signal from the transmission antenna 34 has been responded to and the FLAG data is “010”, the vehicle body-side apparatus 1 can specify that the tire-side apparatus 2 of the identifier 241 corresponding to this FLAG data corresponds to the rear-left tire T.

In this manner, the correspondence between the tire T and the identifier 241 of the tire-side apparatus 2 can be specified by the vehicle body-side apparatus 1 in response to the comparison result of the signal reception strengths, without comparing with a threshold value stored in advance, through the processing described above, in any cross-talk state.

Description will be given using a specific example. First, it is assumed that the identifiers 241 of the tire-side apparatuses 2 are as follows.

Identifier 241 of tire-side apparatus 2 of front-left tire T: “XXX”

Identifier 241 of tire-side apparatus 2 of front-right tire T: “XXY”

Identifier 241 of tire-side apparatus 2 of rear-left tire T: “XXW”

Identifier 241 of tire-side apparatus 2 of rear-right tire T: “XXZ”

Also, it is assumed that the cross-talk occurrence states are as follows.

Identifiers 241 of tire-side apparatuses 2 that responded to transmission antenna 31→XXX, XXY, XXW

Identifiers 241 of tire-side apparatuses 2 that responded to transmission antenna 32→XXZ, XXW

Identifiers 241 of tire-side apparatuses 2 that responded to transmission antenna 33→XXZ, XXW

Identifiers 241 of tire-side apparatuses 2 that responded to transmission antenna 34→XXX, XXY

Also, it is assumed that the reception states of the measurement signals in the tire-side apparatuses 2 (parentheses are corresponding identifiers 241) of the tires T are as follows.

Front-right (XXY): number of measurement signals “2”, highest-strength signal reception order “1”→FLAG “10”

Rear-right (XXW): number of measurement signals “3”, highest-strength signal reception order “2”→FLAG “010”

Front-left (XXX): number of measurement signals “2”, highest-strength signal reception order “2”→FLAG “01”

Rear-left (XXZ): number of measurement signals “2”, highest-strength signal reception order “2”→FLAG “01”

Note that the above-described FLAG data is updated as follows each time a measurement signal is transmitted.

Front-right (XXY):

FR signal received “1”→RR signal not received “1”→RL signal not received “1”→FL signal received “10”

Rear-right (XXW):

FR signal received “1”→RR signal received “01”→RL signal received “010”→FL signal not received “010”

Front-left (XXX):

FR signal not received→RR signal received “1”→RL signal received “01”→FL signal not received “01”

Rear-left (XXZ):

FR signal received “1”→RR signal not received “1”→RL signal not received “1”→FL signal received “01”

The control unit 10 of the vehicle body-side apparatus 1 determines the correspondence between the tire positions corresponding to the address order and the identifiers 241 through the following procedure based on these pieces of information.

1: Front-right (FR) tire-side apparatus 2

Response signals are transmitted from the tire-side apparatuses 2 whose identifiers 241 are “XXX, XXY, XXW”, in response to measurement signal transmitted from the transmission antenna 31 that is first in the address order. The pieces of FLAG data to which these identifiers 241 correspond are “01”, “10,” and “010” respectively. The control unit 10 stores in advance the fact that the transmission order of the measurement signal from the transmission antenna 31 is “first”. The control unit 10 specifies that the FLAG data in which the order corresponding to the transmission order “1” of the front-right tire-side apparatus 2 has the highest signal reception strength is only “10”. Accordingly, in step 109, the control unit 10 determines the correspondence between the address order “1”, that is, the tire position (FR), and the identifier 241 “XXY” for the FLAG data “10”.

2: Front-left (FL) tire-side apparatus 2

Response signals are transmitted from the tire-side apparatuses 2 whose identifiers 241 are “XXX, XXY”, in response to a measurement signal transmitted from the transmission antenna 34 corresponding to the front-left tire T (FL), which is last in the address order. Since the correspondence of the identifier 241 “XXY” has been determined in (1) above, the control unit 10 can determine the correspondence between the tire position (FL) and the identifier 241 “XXX”. However, if it is assumed that determination is performed based on the FLAG data, the pieces of FLAG data to which the identifiers 241 correspond are “01” and “10”. The control unit 10 stores in advance the fact that the transmission order of the measurement signal from the transmission antenna 34 corresponding to front-left is “fourth”. The control unit 10 specifies that the FLAG data in which the order corresponding to the transmission order “4” of the front-left tire-side apparatus 2 has the highest signal reception strength is only “01”. Accordingly, in step 109, the control unit 10 determines the correspondence between the address order “1”, that is, the tire position (FL), and the identifier 241 “XXX” for the FLAG data “01”.

3: Rear-right (RR) tire-side apparatus 2

Response signals are transmitted from the tire-side apparatuses 2 whose identifiers 241 are “XXZ, XXW”, in response to the measurement signal transmitted from the transmission antenna 32 that is second in the address order. The pieces of FLAG data to which these identifiers 241 correspond are “01”, and “010” respectively. If the measurement signal transmitted from the transmission antenna 32 whose transmission order is second is received with the highest strength and the FLAG data is “01”, it is determined that a measurement signal has also been received before the measurement signal received from the transmission antenna 32. That is, it is expected that the tire-side apparatus 2 (XXZ) has also received the measurement signal from the transmission antenna 31 that first transmitted a measurement signal, and thus that the tire-side apparatus 2 (XXZ) has transmitted a response signal. The identifiers 241 of the tire-side apparatuses 2 that responded to the signal transmission antenna 31 are “XXX, XXY, XXW”, and do not include “XXZ”. Accordingly, the control unit 10 determines that the tire-side apparatus 2 that received, with the highest strength, the measurement signal transmitted from the transmission antenna 32 whose transmission order is second cannot be “XXZ”. At this time, in step 109, the control unit may also determine the correspondence between the address order “2”, that is, the tire position (RR), and the identifier 241 “XXW” for the FLAG data “010”. For the sake of confirmation, if the FLAG data is “010” and the measurement signal transmitted from the transmission antenna 32 whose transmission order is second is received with the highest strength, it is expected that the FLAG data responds to the signals from both the first and second transmission antennas 31 and 32 and from the third antenna 33 or the fourth antenna 34. The tire-side apparatus 2 for the identifier 241 “XXW” has responded to the measurement signals from the transmission antennas 31, 32, and 33, and there is no discrepancy, and therefore the control unit 10 can determine the correspondence between the tire position (RR) and the identifier 241 “XXW”.

4: Rear-left (RL) tire-side apparatus 2

Response signals are transmitted from the tire-side apparatuses 2 whose identifiers 241 are “XXZ, XXW”, in response to the measurement signal transmitted from the transmission antenna 33 that is third in the address order. Since the correspondence of the identifier 241 “XXW” has been determined in (3) above, the control unit 10 can determine the correspondence between the tire position (RL) and the identifier 241 “XXZ”. However, if it is assumed that determination is performed based on the FLAG data, the pieces of FLAG data to which these identifiers 241 correspond are “01” and “010” respectively, but if the measurement signal transmitted from the transmission antenna 33 whose transmission order is third is received with the highest strength and the FLAG data is “010”, the tire-side apparatus 2 “XXW” is expected to have transmitted the response signal to the measurement signal from the transmission antenna 34 as well, as shown in FIG. 3. However, the tire-side apparatus 2 with the identifier 241 “XXW” has not responded to the measurement signal from the transmission antenna 34 and there is a discrepancy, and therefore the control unit 10 can determine that the identifier 241 “XXW” does not correspond to the tire position (RL). If the measurement signal transmitted from the transmission antenna 33 whose transmission order is third is received with the highest strength and the FLAG data is “01”, it is expected that the response signal has not been transmitted in response to the measurement signal transmitted from the fourth transmission antenna 34. Since the tire-side apparatus 2 with the identifier “XXZ” has not responded to the measurement signal from the transmission antenna 34, there is no discrepancy, and therefore, accordingly, the control unit 10 can determine the correspondence between the tire position (RL) and the identifier 241 “XXZ”.

In this manner, the measurement signals are transmitted from the vehicle body-side apparatus 1 in a predetermined order, and the number of received measurement signals in the tire-side apparatuses 2 and FLAG data indicating the highest-strength signal reception order are stored in the tire-side apparatuses 2. The tire-side apparatuses 2 compare the signal reception strengths of the received signals, but it is sufficient that the tire-side apparatuses 2 create FLAG data and transmit the FLAG data to the vehicle body-side apparatus 1 without comparing the signal reception strengths with a set threshold value. Since the address order of the measurement signals is kept track of in the vehicle body-side apparatus 1, it is possible to identify the address order to which the tire-side apparatus 2 corresponds, that is, the tire position to which the tire-side apparatus 2 corresponds, by referencing the candidates. Accordingly, thereafter, the vehicle body-side apparatus 1 can acquire the result of measuring the air pressure by identifying the tires T accurately.

In the present embodiment, a tire air pressure detection system was described, but as described above, the vehicle body-side apparatus 1 is a BCM unit, and therefore the transmission antennas 31 to 34 and the reception antenna 4 may also be used in another communication system. The communication system is, for example, a passive entry system. The passive entry system is constituted by the vehicle body-side apparatus 1 and a mobile device for the passive entry system. The vehicle body-side apparatus 1 uses some or all of the transmission antennas 31 to 34 and the reception antenna 4 to perform wireless communication with the mobile device possessed by a user, authenticate the mobile device, and detect the position of the mobile device. If a touch sensor (not shown) is provided on the door handle of the vehicle V and it is detected by the touch sensor that a hand of the user has touched the door handle, or if a door switch is pressed, or the like, when the legitimate mobile device is located outside of the vehicle, the vehicle body-side apparatus 1 executes processing such as locking and unlocking of the door of the vehicle V. When wireless communication with the mobile device is to be performed, the vehicle body-side apparatus 1 need only select a strong stage of signal output from the transmission antennas 31 to 34, and when a signal is to be transmitted to the tire-side apparatus 2, the vehicle body-side apparatus 1 need only select a stage of signal output of the transmission antennas 31 to 34 that is as low as possible. The passive entry system is an example, and the system of the present disclosure can be applied to a system for performing control by performing wireless communication between the vehicle body-side apparatus 1 and another wireless communication apparatus. For example, the vehicle communication system may constitute, in addition to a TPMS, a keyless entry system, a smart start (registered trademark) system that enables startup of a motor, air-conditioning, or the like equipped in a vehicle V without using a mechanical key, or the like.

The embodiment disclosed herein is to be thought of as being in all respects illustrative and in no respects limiting. The scope of the present disclosure is indicated not by the above-described meanings but by the claims, and is intended to encompass meanings equivalent to the claims and all modifications within the scope.

1. A tire air pressure detection system including: tire-side apparatuses that are respectively provided on a plurality of tires mounted on a vehicle, each tire-side apparatus having a sensor for detecting air pressure of the tire, a tire-side reception unit for wirelessly receiving a signal requesting transmission of a result of measurement performed by the sensor, and a tire-side transmission unit for wirelessly transmitting a measurement result in response to the request; and a vehicle body-side apparatus that is provided on a vehicle body of the vehicle and has a vehicle body-side transmission unit and a vehicle body-side reception unit that are provided on the vehicle body of the vehicle and are for wirelessly transmitting and receiving signals to and from the tire-side apparatuses, the vehicle body-side apparatus acquiring air pressures of the respective tires and detecting reduction of the air pressures, wherein
each of the tire-side apparatuses includes:
a first storage unit configured to store an identifier for identifying the tire-side apparatus in which the first storage unit is included;
a signal reception strength measurement unit configured to measure a signal reception strength of each of the measurement signals;
a specification unit configured to specify the number of measurement signals received by the tire-side reception unit;
a second storage unit configured to store the number of the received measurement signals among the measurement signals transmitted sequentially from the vehicle body-side apparatus to the tire-side apparatuses corresponding to the plurality of tires, and a signal reception order in which a measurement signal with the highest signal reception strength among the received measurement signals was received; and
a tire-side transmission control unit configured to cause a response signal, which includes information indicating the number of measurement signals and the signal reception order stored in the second storage unit and an identifier stored in the first storage unit, to be transmitted to the vehicle body-side apparatus, and the vehicle body-side apparatus includes:
a vehicle body-side transmission control unit configured to cause measurement signals to be sequentially transmitted from the vehicle body-side transmission unit in accordance with an address order to the tire-side apparatuses of the plurality of tires;
a vehicle body-side reception control unit configured to receive response signals through the vehicle body-side reception unit after transmission of the measurement signals; and
a control unit configured to retrieve the identifiers, the numbers of measurement signals, and the signal reception orders included in the response signals transmitted from the plurality of tire-side apparatuses and, based on comparison, associate tire positions corresponding to the address order and the identifiers.

2. The tire air pressure detection system according to claim 1, wherein
if the control unit receives a plurality of response signals after transmitting a request signal requesting transmission of a measurement result to any one of the tire-side apparatuses, the control unit stores the correspondence between the tire position corresponding to a request destination of the request signal and the identifiers included in the response signals, and
based on the identifiers, numbers of response signals, and response orders included in the response signals, and based on a correspondence between the tire position and an identifier stored in advance, the control unit associates the tire position corresponding to the address order and the identifier.

3. A vehicle body-side apparatus that is provided on a vehicle body of a vehicle and includes: a transmission unit and a reception unit for transmitting and receiving information using wireless signals to and from tire-side apparatuses provided in a plurality of tires mounted on the vehicle, the vehicle body-side apparatus comprising:
a transmission control unit configured to sequentially cause measurement signals to be transmitted from the transmission unit in accordance with a predetermined address order to the tire-side apparatuses of the plurality of tires;
a reception control unit configured to receive response signals through the reception unit after transmission of the measurement signals; and
a control unit configured to retrieve the identifiers, the numbers of measurement signals, and the signal reception orders included in the response signals transmitted from the plurality of tire-side apparatuses and, based on mutual comparison of the retrieved numbers of measurement signals and the signal reception order, associate tire positions corresponding to the predetermined address order and the identifiers.

4. A tire-side apparatus that is provided on a tire of a vehicle and includes a transmission unit and a reception unit for transmitting and receiving information through wireless signals to and from a vehicle body-side apparatus provided on a vehicle body of the vehicle, the tire-side apparatus comprising:
a first storage unit configured to store an identifier for identifying the tire-side apparatus in which the first storage unit is included;
a signal reception strength measurement unit configured to measure a signal reception strength of each of the measurement signals;
a specification unit configured to specify the number of measurement signals received by the reception unit;
a second storage unit configured to store the specified number of the received measurement signals among the measurement signals transmitted sequentially from the vehicle body-side apparatus to the tire-side apparatus, and a signal reception order in which a measurement signal with the highest signal reception strength among the received measurement signals was received; and
a transmission control unit configured to cause a response signal, which includes information indicating the number of measurement signals and the signal reception order stored in the second storage unit and an identifier stored in the first storage unit, to be transmitted to the vehicle body-side apparatus.
